(19) United States
(12) Patent Application Publication
(10) Pub. No.: US 2010/0154057 A1
(43) Pub. Date: Jun. 17, 2010

(54) SIP INTRUSION DETECTION AND RESPONSE ARCHITECTURE FOR PROTECTING SIP-BASED SERVICES

(75) Inventors: Kyoung Hee KO, Dong-gu (KR); Hwan-Kuk Kim, Seoul (KR); JeongWook Kim, Seongnam-si (KR); Chang-Yong Lee, Seoul (KR); HyunCheol Jeong, Seoul (KR)

Correspondence Address: THE FARRELL LAW FIRM, LLP, 290 Broadhollow Road, Suite 210E, Melville, NY, 11747, US

(73) Assignee: Korea Information Security Agency, Seoul (KR)

(21) Appl. No.: 12/353,722

(22) Filed: Jan. 14, 2009

(30) Foreign Application Priority Data
Dec. 16, 2008 (KR) 2008-0128081

(51) Int. Cl. G06F 11/00; G06F 9/00

(52) U.S. Cl. 726/23; 726/13

(57) ABSTRACT

The present invention relates to a Session Initiation Protocol (SIP) intrusion detection and response architecture for protecting SIP-based services, and more specifically, to an SIP intrusion detection and response architecture for protecting SIP-based services, in which SIP-based attacks of a new type can be coped with by detecting the SIP-based attacks and SIP traffic anomalies and managing an SIP-aware security device without degrading quality of multimedia, and signal and media channels can be examined through an SIP-aware intrusion prevention system (IPS) for the purpose of preventing an attacker from hindering a call through manipulation of an SIP message and session-hijacking among legitimate users and attempting a toll fraud by detouring authentication.

### BACKGROUND OF THE INVENTION

1. Field of the Invention

The present invention relates to a Session Initiation Protocol (SIP) intrusion detection and response architecture for protecting SIP-based services, in which SIP-based attacks of a new type can be coped with by detecting the SIP-based attacks and SIP traffic anomalies and managing an SIP-aware security device without degrading quality of multimedia, and signal and media channels can be examined through an SIP-aware intrusion prevention system (IPS) for the purpose of preventing an attacker from hindering a call through manipulation of an SIP message and session-hijacking among legitimate users and attempting a toll fraud by detouring authentication. Although the SIP-aware IPS may detect a distributed denial of service (DDos) attack, since traffic analysis can place a big burden on the SIP-aware IPS, traffic monitoring sensors are installed at choke points of a network, and traffic data collected through the sensors can be analyzed by a traffic analyzer. The SIP-aware IPS, an SIP traffic anomaly detection system, and other SIP servers can be consistently operated and managed in the SIP intrusion detection and response architecture.

2. Background of the Related Art

Session Initiation Protocol (SIP) is a signaling protocol for initiating, managing, and terminating multimedia sessions. SIP-based services are IP multimedia communication services such as VoIP (Voice over Internet Protocol), presence service, instant messaging, and video conferencing.

SIP was developed by IETF (Internet Engineering Task Force). After 3GPP (3rd Generation Partnership Project) had selected SIP as a signaling protocol for IMS (IP Multimedia Core Network Subsystem), a variety of SIP-related standards has been appeared in companied with the 3GPP's IMS. Therefore, it is expected that SIP plays an important part in IP multimedia services. For example, in Korea, SIP-based VoIP services begin to gain popularity as a result of government's promoting policies, service providers' marketing strategies, low service rates, and various value-added services.

However, since the SIP-based services are provided over the Internet, there are security threats, such as viruses or worms, inherited from Internet environments. In addition, since the SIP-based services are introduction of a new technique for transmitting multimedia traffic through the Internet, there are new security threats.

Conventional IP-based security solutions have evolved to cope with attacks on the SIP-based services. However, since these solutions should take into account the characteristics described below in coping with the SIP-based attacks, there are limits in the SIP-based services.

First, signaling paths are separated from media traffic paths in the SIP-based services. Like other multimedia protocols such as Windows Media Technology, Real Media, and QuickTime, the SIP-based services use SIP as a signaling protocol for establishing a session and RTP (Real-time Transport Protocol) as a media protocol for transferring streaming data. It means that a cross protocol intrusion detection approach should be used. Here, the cross protocol intrusion detection is a function of rule matching expanded to multiple protocols, e.g., detecting patterns in an SIP packet and succeeding RTP packets.

Second, the SIP-based services are sensitive to network QoS (Quality of Service) such as delay, jitter, and packet loss. This means that performance of detection and response is very critical. That is, the detection and response should not degrade QoS even if a detection mechanism requires excessive packet inspection in order to parse the payload of packets in the application layer. This also means that it is needed to keep track of network QoS metrics to monitor end-to-end service quality.

Related works for protecting the SIP-based services are divided into three groups. First, there are SIP-aware ALGs (application level gateways) such as SIPAssure. While conventional firewall solutions open a certain range of ports in order to support RTP, SIP-aware ALGs provide dynamic pinhole filtering which can dynamically open and close media ports for the sake of a call, on the basis of negotiations observed while signaling. But this approach is focused on filtering, not detecting, the SIP-based attacks.

Second, a conventional Intrusion Detection System (IDS) expands its detection capability for detecting SIP-based attacks. The conventional IDS includes TippingPoint and SNOCER projects. This group can detect malformed SIP messages and SIP DoS (Denial of Service) based on a signature-based detection scheme. However, their signatures are rather limited, and they cannot detect sophisticated SIP-based attacks such as a toll fraud.

Third, there are SIP-aware security devices such as Sipera IPCS and VoIP SEAL. Sipera IPCS provides VPN (Virtual Private LAN), IPS (Intrusion Prevention System), and Anti-Spam based on VoIP SBC (Session Border Controller). VoIP SEAL provides solutions for filtering spam propagated through Internet telephony. However, all of the studies described above are limited in the SIP intrusion detection and response for protecting the SIP-based services.

Therefore, there is an urgent need for development of an SIP intrusion detection and response architecture for protecting SIP-based services, which can cope with SIP-based attacks of a new type without degrading quality of multimedia, examine signal and media channels through an SIP-aware IPS for the purpose of preventing an attacker from hindering a call through manipulation of an SIP message and session-hijacking among legitimate users and attempting a toll fraud by detouring authentication, analyze traffic data collected by traffic monitoring sensors installed at choke points of a network using a traffic analyzer, and consistently operate and manage the SIP-aware IPS, an SIP traffic anomaly detection system, and other SIP servers.

### SUMMARY OF THE INVENTION

Therefore, the present invention has been made in an effort to solve the above problems occurring in the prior art, and it is an object of the present invention to provide an SIP intrusion detection and response architecture for protecting SIP-based services, in which SIP-based attacks of a new type can be coped with by detecting the SIP-based attacks and SIP traffic anomalies and managing an SIP-aware security device without degrading quality of multimedia.

Another object of the present invention is to provide an SIP intrusion detection and response architecture for protecting SIP-based services, in which signal and media channels can be examined through an SIP-aware IPS for the purpose of preventing an attacker from hindering a call through manipulation of an SIP message and session-hijacking among legitimate users and attempting a toll fraud by detouring authentication.

Still another object of the present invention is to provide an SIP intrusion detection and response architecture for protecting SIP-based services, in which although the SIP-aware IPS may detect a DDos attack, since traffic analysis can be a big burden on the SIP-aware IPS, traffic monitoring sensors are installed at choke points of a network, and traffic data collected by the sensors can be analyzed through a traffic analyzer.

Yet another object of the present invention is to provide an SIP intrusion detection and response architecture for protecting SIP-based services, in which the SIP-aware IPS, an SIP traffic anomaly detection system, and other SIP servers can be consistently operated and managed.

To accomplish the above objects, according to a preferred embodiment of the present invention, there is provided an SIP intrusion detection and response architecture for protecting SIP-based services, the architecture including: an SIP intrusion protection system installed in a series for detecting and responding to SIP-based attacks by communicating with an SIP security management system agent; an SIP traffic anomaly detection engine for communicating with the SIP security management system agent and detecting anomalies of traffic based on netflow data; an SIP security management system manager for communicating with the SIP security management system agent, and determining with further higher reliability that the network is attacked and managing the SIP intrusion protection system if a traffic anomaly event is received from the SIP traffic anomaly detection engine and simultaneously a security event are received from the SIP intrusion protection system; and an SIP traffic anomaly detection sensor for transferring data collected based on the netflow data to the SIP traffic anomaly detection engine through an SIP Flow transmitter section.

In the present invention, the SIP intrusion protection system may include: a packet bypass/monitoring section for monitoring and capturing all packets coming in and going out of SIP servers; an SIP signature-based detection section and an RTP signature-based detection section for detecting INVITE messages and SIP REGISTER messages as DoS attacks if the amount of the INVITE messages and the SIP REGISTER messages transmitted from various source Uniform Resource Identifiers (URIs) to a specific destination URI per unit time exceeds a certain amount, and detecting RTP DoS attacks and SIP DoS attacks; an SIP protocol state-based detection section for detecting SIP service abuse aiming at a toll fraud and detecting call interruption attacks that hinders communications between legitimate users; an SIP protocol decoder/syntax check section and an RTP protocol decoder/syntax check section for detecting fuzzing attacks by checking syntax; an SIP attack quarantine section and an RTP attack quarantine section for dropping packets corresponding to an attack or filtering the packets using a predefined filtering rule when the SIP intrusion detection system detects the attack; an SIP intrusion detection system management/View GUI section used for an administrator who monitors and manages the SIP intrusion detection system; an SIP traffic anomaly detection system interface section for transferring intrusion detection data between the SIP intrusion detection system and the SIP traffic anomaly detection system; and a client-side SIP security management system interface library section subordinated to the SIP security management system, for allowing the SIP intrusion detection system to communicate with the SIP security management system agent.

In the present invention, the SIP traffic anomaly detection sensor may include: a raw packet collecting section for monitoring traffic data transmitted from network devices such as a router and a switch; an SIP packet identification/classification section for identifying SIP packets and RTP packets corresponding to the SIP packets; an SIP flow generation section for generating the netflow data; and an SIP Flow transmitter section for transferring data collected based on the netflow data to the SIP traffic anomaly detection sensor (→engine).

In the present invention, the SIP traffic anomaly detection engine may include: an SIP flow collection section for collecting the netflow data from various sensors; an SIP traffic analyzer engine section for analyzing the netflow data and detecting traffic anomalies based on a history pattern; a profiling-based detection engine section for detecting a system's abnormal behavior using a ratio of SIP request/response messages of INVITE for a user; an SIP traffic anomaly detection management/View GUI section used for an administrator who monitors and manages the SIP traffic anomaly detection system; an SIP intrusion protection system interface section for transferring intrusion detection data between the SIP traffic anomaly detection system and the SIP intrusion detection system; and a client-side SIP security management system interface library section for allowing the SIP traffic anomaly detection system to communicate with the SIP security management system agent.

In the present invention, the SIP security management system agent collects security events, system resource information, call statistics, and traffic statistics from the SIP intrusion detection system, SIP traffic anomaly detection system, and other SIP-aware network devices, such as an SIP proxy and a Session Border Controller (SBC), the SIP security management system agent comprising: client-side and server-side SIP security management system interface library sections of the SIP security management system agent for providing APIs for purposing a format and method for exchanging messages in order to collect various data and control other existing systems; a normalization section and an aggregation section for normalizing and aggregating the security event so that the security event can be used later; and a transceiver section for allowing the SIP security management system agent and the SIP security management system manager to communicate with each other.

In the present invention, the SIP security management system manager may include: a security event correlation engine section for correlating collected events based on a predefined rule and an attack scenario; a management control section for controlling various devices and converting a user's control command into a predefined management message format; an SIP security management system management/View GUI section for monitoring and managing various devices and the SIP security management system itself; and a transceiver section for allowing the SIP security management system agent and the SIP security management system manager to communicate with each other.

In the present invention, a combination of the SIP intrusion protection system and the SIP security management system agent, a combination of the SIP traffic anomaly detection engine and the SIP security management system agent, the SIP security management system manager, and the SIP traffic anomaly detection sensor can be used independently or in a combination of a single or plurality thereof.

In the present invention, the SIP intrusion protection system is positioned at a front end of the SBC to examine both of signal and media channels or distributed to signal and media channel paths to examine respective channels, and in a latter case, a result of examining the respective channels is integrated and analyzed through the SIP security management system.

The SIP intrusion detection and response architecture for protecting SIP-based services according to the present invention has following effects.

First, in the present invention, SIP-based attacks of a new type can be coped with by detecting the SIP-based attacks and SIP traffic anomalies and managing an SIP-aware security device without degrading quality of multimedia.

Second, in the present invention, signal and media channels can be examined through an SIP-aware IPS for the purpose of preventing an attacker from hindering a call through manipulation of an SIP message and session-hijacking among legitimate users and attempting a toll fraud by detouring authentication.

Third, in the present invention, although the SIP-aware IPS may detect a DDos attack, since traffic analysis can be a big burden on the SIP-aware IPS, traffic monitoring sensors are installed at choke points of a network, and traffic data collected by the sensors can be analyzed through a traffic analyzer.

Fourth, in the present invention, the SIP-aware IPS, an SIP traffic anomaly detection system, and other SIP servers can be consistently operated and managed.

### BRIEF DESCRIPTION OF THE DRAWINGS

FIG. 1 is a view showing factors of security threat and a security solution in an SIP-based service according to an embodiment of the present invention.

FIG. 2 is a view showing an SIP intrusion detection and response architecture for protecting SIP-based services according to an embodiment of the present invention.

### DETAILED DESCRIPTION OF THE PREFERRED EMBODIMENT

Hereinafter, a preferred embodiment of the invention will be explained in detail with reference to the accompanying drawings. In the explanation of embodiments, details well-known in the art and not related directly to the invention may be omitted to avoid unnecessarily obscuring the invention and convey the gist of the invention more clearly. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. Thus, such a special definition will be expressly set forth in the specification in a definitional manner that directly and unequivocally provides the special definition for the term or phrase.

Hereinafter, an SIP intrusion detection and response architecture for protecting SIP-based services according to a preferred embodiment of the present invention will be described in detail with reference to the accompanying drawings.

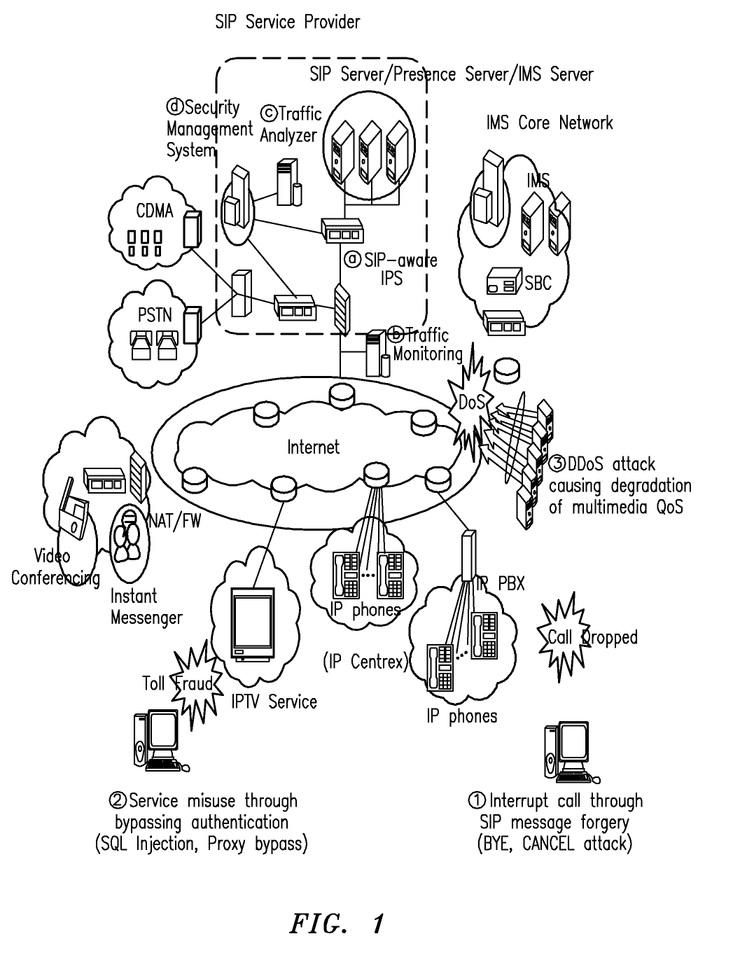

FIG. 1 is a view showing factors of security threat and a security solution in an SIP-based service according to an embodiment of the present invention.

An SIP service provider includes an SIP proxy server, an SIP registrar server, an SIP redirect server, a presence server, and an IMS server, for providing VoIP, video conferencing, instant messaging, and IPTV service. Conventional IP-based firewalls are deployed at the front end of the servers or network perimeters.

Attackers can interrupt a call by manipulating an SIP message and hijacking a session among legitimate users.(□) The attackers may also attempt a toll fraud by detouring authentication.(□) In order to block these kinds of attacks, SIP-aware IPS(□) for inspecting signal and media channels is needed.

The attackers can infect many computers with malicious programs like worms and Trojans. The infected computers become zombies and obey the master's control. This is one possible scenario of a DDoS (Distributed Denial of Service) attack on the SIP server. To detect the DDoS attack □, it is needed to monitor traffic and detect traffic anomalies. Although SIP-aware IPS can detect the DDoS attack, traffic analysis can be a big burden on the SIP-aware IPS. Therefore, it is advantageous to install traffic monitoring sensors □ at network choke points. Traffic data gathered by the sensors are analyzed by a traffic analyzer □. A security management system □ is needed to consistently operate and manage the SIP-aware IPS, the SIP traffic anomaly detection system, and other SIP servers.

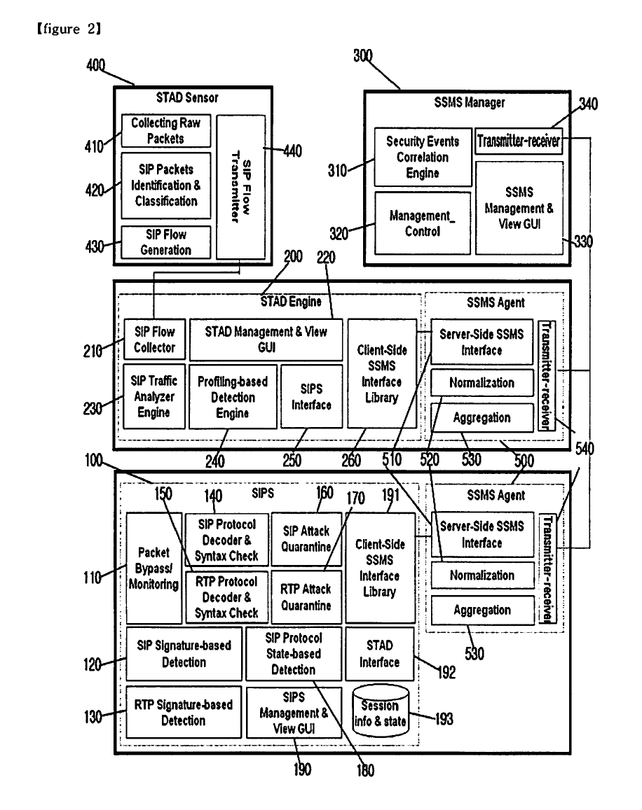

FIG. 2 is a view showing an SIP intrusion detection and response architecture for protecting SIP-based services according to an embodiment of the present invention.

As shown in FIG. 2, the SIP intrusion detection and response architecture for protecting SIP-based services includes an SIP intrusion protection system 100 installed in a series for detecting and responding to SIP-based attacks by communicating with an SIP security management system agent 500 that collects and transfers data through a network, an SIP traffic anomaly detection engine 200 for communicating with the SIP security management system agent 500 and detecting anomalies of traffic based on netflow data, an SIP security management system manager 300 for communicating with the SIP security management system agent 500, and determining with further higher reliability that the network is attacked and managing the SIP intrusion protection system if a traffic anomaly event is received from the SIP traffic anomaly detection engine 200 and simultaneously a security event are received from the SIP intrusion protection system 100, and an SIP traffic anomaly detection sensor 400 for transferring data collected based on the netflow data to the SIP traffic anomaly detection engine 200 through an SIP Flow transmitter section 440.

The configurations and functions of technical means that construct the SIP intrusion detection and response architecture for protecting SIP-based services according to the present invention are as described below.

The SIP intrusion protection system 100 installed in a series communicates with the SIP security management system agent 500, which collects and transfers data through networks, and detects and responses to SIP-based attacks.

Internal components of the SIP intrusion protection system (SIPS) are described below. The SIPS is designed to be installed in a series. In FIG. 2, a packet bypass/monitoring section 110 monitors and captures all packets coming in and going out of the SIP servers.

SIP-based attacks are classified into four categories, and a detection mechanism of each attack category will be described.

First, it is SIP DoS that consumes available system resources or network bandwidth. SIP INVITE message flooding, SIP REGISTER message flooding, and an RTP DoS attack are included in this category. SIP DoS attacks are detected by signature-based detection mechanism. For example, if the amount of INVITE messages transmitted from various source Uniform Resource Identifiers (URIs) to a specific destination URI per unit time exceeds a certain amount, the SIPS detects these messages as a DoS attack. In FIG. 2, an SIP signature-based detection section 120 and an RTP signature-based detection section 130 are responsible for this function. The SIP signature-based detection section 120 manages a rule table as shown in Table 1 in order to detect the SIP DoS.

TABLE 1
Rule table for detecting SIP DoS

| | | | | | | | | | | |
|---|---|---|---|---|---|---|---|---|---|---|
| No | Time | IP | Port | SIP | From | To | Via | Threshold | Interval | Action |

| | | | | | | | |
|---|---|---|---|---|---|---|---|
| of | Src | Dst | Src | Dst | Method | URI | URI |
| Day | | | | | | | |

Second, it is SIP service abuse aiming at a toll fraud. Registration hijacking, registration forgery through SQL injection, InviteReplay attack, FakeBusy attack, ByeDelay attack, and ByeDrop attack are included in this category. The SQL injection is detected by a signature-based detection mechanism. The other attacks belonging to this category will be detected based on a transition model of the SIP session information and protocol state 193. The SIP signature-based detection section 120 and an SIP protocol state-based detection section 180 are responsible for this function. Table 2 shows an SIP session information table managed by he SIP protocol state-based detection section 180.

TABLE 2
SIP Session Info table for detecting SIP service abuse

| | | | | | | | | | | |
|---|---|---|---|---|---|---|---|---|---|---|
| Dialog | Transaction | Method | From | To | Call- | Via | CSeq | Max- | Finger- | Status |
| ID | | | | | ID | | | Forwards | print | |

Third, it is call interruption that hinders communications between legitimate users. AN SIP CANCEL attack, a deregistration attack, an RTP insertion attack, and an SIP-BYE attack are included in this category. Call interruption attacks can be detected by a protocol state transition model and call setup information. The SIPS manages call setup information as shown Table 3.

TABLE 3
Call setup table for detecting call interruption

| | | | | | | |
|---|---|---|---|---|---|---|
| No | IP | Port | Protocol | From URI | To URI | Action |

| | | | |
|---|---|---|---|
| Src | Dst | Src | Dst |

If an incoming packet is an RTP packet transmitted from an SIP user who does not establish any session with other users, the RTP packet will be assumed as an RTP insertion attack. The SIP protocol state-based detection section 180 is responsible for this function.

Fourth, it is a fuzzing attack that crashes a system or application. The fuzzing attack uses a malformed SIP header format that is not allowed or specified in IETF RFC 3261. The fuzzing attack is detected by checking syntax. AN SIP protocol decoder/syntax check section 140 and an RTP protocol decoder/syntax check section 150 are responsible for this function. Patterns of malformed messages can be obtained using SIP torture test messages of IETF RFC 4475 and protocol testing tools such as Abacus and ThreatEx. These patterns are systemized as a rule shown in Table 4.

TABLE 4
Rule table for detecting malformed SIP Header

| Template | Header | Header | Length | | NumSub | Occurrence | | | |
|---|---|---|---|---|---|---|---|---|---|
| ID | ID | Name | Min | Max | Fields | Min | Max | Delimiter | Action |
| 1 | 1 | To | 32 | 256 | 3 | 1 | 1 | CRLF | |
| 1 | 2 | CSEQ | 4 | 32 | 2 | 1 | 1 | CRLF | |
| 1 | 3 | Via | 16 | 128 | 4 | 1 | 4 | CRLF | |

When the SIPS 100 detects an attack, it drops packets corresponding to the attack or filters the packets according to a predefined filtering rule. An SIP attack quarantine section 160 and an RTP attack quarantine section 170 are responsible for this function. Since the SIPS is designed to be installed in a series, it is critical to process packets without degradation of performance.

In addition, there are a graphical user interface (GUI) section and an interface section. An SIPS management/View GUI section 190 is used for an administrator who monitors and manages the SIPS. An SIP traffic anomaly detection system (STAD) interface section 192 is for transferring intrusion detection data between the SIPS and the STAD. A client-side SIP security management system (SSMS) interface library section 191 is subordinates to the SIP security management system agent 500. Through the interface library, the SIPS communicates with the SIP security management system agent.

The SIP traffic anomaly detection engine 200 communicates with the SIP security management system agent 500 that collects and transfers data through the network and detects anomalies of traffic based on netflow data. In addition, the SIP traffic anomaly detection sensor 400 transfers data collected based on the netflow data to the SIP traffic anomaly detection engine 200 through the SIP Flow transmitter section 440.

Constitutional elements included in the SIP traffic anomaly detection (STAD) system are described below. The SIP traffic anomaly detection system comprises an SIP traffic anomaly detection sensor 400 and an SIP traffic anomaly detection engine 200.

A raw packet collecting section 410 in the SIP traffic anomaly detection sensor monitors traffic data transmitted from network devices such as a router and a switch. AN SIP packet identification/classification section 420 identifies SIP packets and RTP packets corresponding to the SIP packets.

AN SIP flow generation section 430 generates netflow data. Processing overheads of the system can be reduced by aggregating packets that belong to the same flow. Netflow version 9 provides a template that allows a user to define application layer metrics, as well as 5-tuple (source IP, source port, destination IP, destination port, and protocol). For example, it is possible to collect netflow data, such as the number of INVITE messages (sip-invite-count), the number of BYE messages (sip-bye-count), and the number of REGISTER messages (sip-register-count), in addition to the metrics shown in Table 5. The SIP traffic anomaly detection sensor 400 transfers the data collected based on the netflow data to the SIP traffic anomaly detection engine through the SIP flow transmitter section 440.

TABLE 5
Traffic metrics for VoIP

| SIP Metrics | RTP Metrics |
|---|---|
| SIP_CALL_ID | RTP_FIRST_SSRC |
| SIP_CALLING_PARTY | RTP_FIRST_TS |
| SIP_CALLED_PARTY | RTP_LAST_SSRC |
| SIP_RTP_CODECS | RTP_LAST_TS |
| SIP_INVITE_TIME | RTP_IN_JITTER |
| SIP_TRYING_TIME | RTP_OUT_JITTER |
| SIP_RINGING_TIME | RTP_IN_PKT_LOST |
| SIP_OK_TIME | RTP_OUT_PKT_LOST |
| SIP_ACK_TIME | RTP_OUT_PAYLOAD_TYPE |
| SIP_RTP_SRC_PORT | RTP_IN_MAX_DELTA |
| SIP_RTP_DST_PORT | RTP_OUT_MAX_DELTA |

If the SIP traffic anomaly detection engine 200 collects the netflow data from various sensors through an SIP flow collection section 210, an SIP traffic analyzer engine section 230 analyzes the netflow data and detects traffic anomalies based on a history pattern. For example, an average jitter (rtp_in_jitter) between 6 and 7 PM on Sunday is calculated. An average of jitters of the same day of a week is calculated for latest 3 months. If the current average jitter is 100% higher than the average of the last 3 months, the STAD engine determines this flow as an anomaly.

It is possible to draw a user's or system's behavior based on the netflow data. For example, the user's abnormal behavior can be detected using the number of INVITE messages (sip-invite-count) received for a month for the user. The system's abnormal behavior can be detected using the number of INVITE messages received for a month for all users. A profiling-based detection engine section 240 is responsible for this function. The SIP traffic anomaly detection engine informs the SIPS and the SSMS of detection data. After receiving the detection data, the SIPS quarantines subsequent connections having the same origin and destination.

The STAD system also has a GUI and an interface section, additionally. The STAD management/View GUI section 220 is used for an administrator who monitors and manages the STAD system. An SIP intrusion protection system interface section 250 is for transferring intrusion detection data between the STAD and the SIPS. A client-side SIP security management system (SSMS) interface library section 260 is subordinates to the SIP security management system agent.

The SIP security management system manager 300 communicates with the SIP security management system agent 500, and determining with further higher that the network is attacked reliability and managing the SIP intrusion protection system if a traffic anomaly event and a security event are simultaneously received from the SIP traffic anomaly detection engine 200 and the SIP intrusion protection system 100.

Constitutional elements included in the SIP security management system (SSMS) are described below. The SIP security management system comprises an SSMS Agents and an SSMS Manager.

The SSMS agent 500 collects security events, system resource information, call statistics, and traffic statistics from the SIPS, STAD, and other SIP-aware network devices, such as an SIP proxy and a Session Border Controller (SBC). In order to collect various data and control other existing systems, a format and method for exchanging messages should be defined. Many standards, such as IETF RFC 4765 and OPSEC, have been proposed for this purpose. Client-side 191 and 260 and server-side 510 SSMS interface library sections of the SIP security management system (SSMS) agent provide APIs for this purpose.

The security event is normalized and aggregated respectively by a normalization section 520 and an aggregation section 530 to be used later. The transceiver sections 340 and 540 of the SSMS agent and manager are used for communicating with each other.

The SSMS manager has a security event correlation engine section 3 10 that is responsible for correlating the collected events based on a predefined rule and an attack scenario. For example, it suppresses multiple instances of the same event. This prohibits too many alerts from bothering a security administrator. If the SSMS simultaneously receives a traffic abnormal event from the STAD and an RTP flooding attack events from SIPS, the SSMS determines that the network is under attack with further higher reliability. Table 6 shows a part of an alert message as an example.

TABLE 6
A part of an alert message for security event correlation analysis

| Message | | | |
|---|---|---|---|
| Type | | Message Field | Meaning |
| Alert | Application | createTime | Time when intrusion |
| Message | Layer | | detection and response |
| | | | is created |
| | | detectTime | Time detected when |
| | | | event for alert is |
| | | | created |
| | | Protocol | Protocol used for |
| | | | attack |
| | | srcIP | Source IP address |
| | | srcPort | Source port number |
| | | fromURI | Transmitter number |
| | | viaURI | via URI |
| | | dstIP | Destination IP address |
| | | dstPort | Destination port |
| | | | number |
| | | mediaPort | Media port number |
| | | | negotiated by SIP |
| | | toURI | Receiver number |
| | | SIPmethodCategory | SIP request and |
| | | | response method |
| | | ClassName | Classification of alert |
| | | Severity-Category | Measure of relative |
| | | | risk |
| | Network Layer | sourceIP | SSMS Agent IP |
| | | | address |

A management control section 320 controls the overall operation of various devices. It converts a user's control command into a predefined management message format. The control message is used to carry out a security policy. For example, the SIPS blocks a specific source URI. In addition, the control message is used to start or stop the SIPS or STAD when the SIPS or STAD explicitly expresses acceptance of a control message from the SSMS. After the SIPS or STAD executes the command from the SSMS, a result of executing the command is transferred to the management control section through the SSMS agent. The SSMS includes a GUI 330 for monitoring and managing various devices and the SSMS itself.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An SIP intrusion detection and response architecture for protecting SIP-based services, the architecture comprising:
an SIP intrusion protection system installed in a series for detecting and responding to SIP-based attacks by communicating with an SIP security management system agent that collects and transfers data through a network;
an SIP traffic anomaly detection engine for communicating with the SIP security management system agent and detecting anomalies of traffic based on netflow data;
an SIP security management system manager for communicating with the SIP security management system agent, and determining with further higher reliability that the network is attacked and managing the SIP intrusion protection system if a traffic anomaly event is received from the SIP traffic anomaly detection engine and simultaneously a security event are received from the SIP intrusion protection system; and
an SIP traffic anomaly detection sensor for transferring data collected based on the netflow data to the SIP traffic anomaly detection engine through an SIP Flow transmitter section.

2. The architecture according to claim 1, wherein the SIP intrusion protection system comprises:
a packet bypass/monitoring section for monitoring and capturing all packets coming in and going out of SIP servers;
an SIP signature-based detection section and an RTP signature-based detection section for detecting INVITE messages and SIP REGISTER messages as DoS attacks if the amount of the INVITE messages and the SIP REGISTER messages transmitted from various source Uniform Resource Identifiers (URIs) to a specific destination URI per unit time exceeds a certain amount, and detecting RTP DoS attacks and SIP DoS attacks;
an SIP protocol state-based detection section for detecting SIP service abuse aiming at a toll fraud and detecting call interruption attacks that hinders communications between legitimate users;
an SIP protocol decoder/syntax check section and an RTP protocol decoder/syntax check section for detecting fuzzing attacks by checking syntax;
an SIP attack quarantine section and an RTP attack quarantine section for dropping packets corresponding to an attack or filtering the packets using a predefined filtering rule when the SIP intrusion detection system detects the attack;
an SIP intrusion detection system management/View GUI section used for an administrator who monitors and manages the SIP intrusion detection system;
an SIP traffic anomaly detection system interface section for transferring intrusion detection data between the SIP intrusion detection system and the SIP traffic anomaly detection system; and
a client-side SIP security management system interface library section subordinated to the SIP security management system, for allowing the SIP intrusion detection system to communicate with the SIP security management system agent.

3. The architecture according to claim 1, wherein the SIP traffic anomaly detection sensor comprises:
a raw packet collecting section for monitoring traffic data transmitted from network devices such as a router and a switch;
an SIP packet identification/classification section for identifying SIP packets and RTP packets corresponding to the SIP packets;
an SIP flow generation section for generating the netflow data; and
an SIP Flow transmitter section for transferring data collected based on the netflow data to the SIP traffic anomaly detection engine.

4. The architecture according to claim 1, wherein the SIP traffic anomaly detection engine comprises:
an SIP flow collection section for collecting the netflow data from various sensors;
an SIP traffic analyzer engine section for analyzing the netflow data and detecting traffic anomalies based on a history pattern;
a profiling-based detection engine section for detecting a system's abnormal behavior using INVITE messages for a user;
an SIP traffic anomaly detection management/View GUI section used for an administrator who monitors and manages the SIP traffic anomaly detection system;
an SIP intrusion protection system interface section for transferring intrusion detection data between the SIP traffic anomaly detection system and the SIP intrusion detection system; and
a client-side SIP security management system interface library section for allowing the SIP traffic anomaly detection system to communicate with the SIP security management system agent.

5. The architecture according to claim 1, wherein the SIP security management system agent collects security events, system resource information, call statistics, and traffic statistics from the SIP intrusion detection system, SIP traffic anomaly detection system, and other SIP-aware network devices, such as an SIP proxy and a Session Border Controller (SBC), the SIP security management system agent comprising:
client-side and server-side SIP security management system interface library sections of the SIP security management system agent for providing APIs for purposing a format and method for exchanging messages in order to collect various data and control other existing systems;
a normalization section and an aggregation section for normalizing and aggregating the security event so that the security event can be used later; and
a transceiver section for allowing the SIP security management system agent and the SIP security management system manager to communicate with each other.

6. The architecture according to claim 1, wherein the SIP security management system manager comprises:
a security event correlation engine section for correlating collected events based on a predefined rule and an attack scenario;
a management control section for controlling various devices and converting a user's control command into a predefined management message format;
an SIP security management system management/View GUI section for monitoring and managing various devices and the SIP security management system itself; and
a transceiver section for allowing the SIP security management system agent and the SIP security management system manager to communicate with each other.

7. The architecture according to claim 1, wherein a combination of the SIP intrusion protection system and the SIP security management system agent, a combination of the SIP traffic anomaly detection engine and the SIP security management system agent, the SIP security management system manager, and the SIP traffic anomaly detection sensor can be used independently or in a combination of a single or plurality thereof.

8. The architecture according to claim 1 or 2, wherein the SIP intrusion protection system is positioned at a front end of the SBC to examine both of signal and media channels or distributed to signal and media channel paths to examine respective channels, and in a latter case, a result of examining the respective channels is integrated and analyzed through the SIP security management system.
